(19) United States
(12) Patent Application Publication
(10) Pub. No.: US 2025/0196591 A1
(43) Pub. Date: Jun. 19, 2025

(54) Ionizer, Filter System and Motor Vehicle

(71) Applicant: MAHLE International GmbH, Stuttgart (DE)

(72) Inventors: Sven PETZNER, Stuttgart (DE); Daniel EBERLE, Stuttgart (DE)

(21) Appl. No.: 18/975,678

(22) Filed: Dec. 10, 2024

(30) Foreign Application Priority Data
Dec. 15, 2023 (DE) 102023135365.9

(51) Int. Cl. B60H 3/00; B03C 3/41; B03C 3/66

(52) U.S. Cl. CPC B60H 3/0078; B03C 3/41; B03C 3/66; B03C 2201/30

(57) ABSTRACT

An ionizer for an electrostatic air filter system, preferably in a motor vehicle is provider. The ionizer has
a generator with a first terminal and second terminal, and which is configured to generate a high voltage between the first terminal and second terminal,
at least one discharge electrode connected to the first terminal, and
at least one counter electrode at a distance to the discharge electrode, which is connected to the ground. An operating safety of the ionoizer can be improved if
the counter electrode is connected to the second terminal, and
if the discharge electrode and counter electrode have a high-impedance connection to the ground.

### CROSS-REFERENCE TO RELATED APPLICATIONS

This application claims priority from German Patent Application No. DE 10 2023 135 365.9, filed on Dec. 15, 2023, the entirety of which is hereby incorporated by reference herein.

The present invention relates to an ionizer for an electrostatic air filter, preferably in a motor vehicle, according to the preamble of claim 1. The invention also relates to an electrostatic filter for a motor vehicle equipped with such an ionizer. The invention further relates to a motor vehicle equipped with such a filter.

To ensure comfortable and healthy air quality, contaminants such as particulate matter, harmful gasses such as hydrocarbons and nitrous oxides, and unpleasant odors such as ammonia, trimethylamine, hydrogen sulfide, etc. must be removed from the air in, or supplied to, a vehicle interior or passenger compartment. High levels of particulate matter in the air, in particular in urban Asian areas, are a major problem. The daily mean for this in large cities is frequently higher than the PM2.5 value stipulated by WHO, or a mean value of 15 μg/m3. Dust entering a vehicle interior through a fresh air system is usually removed with a filter element in a filter system in the fresh air system, in which the filter element is a particle filter with a fiber filter layer for removing these particles. This filter element is crucial for the air quality in the vehicle interior.

There is very little installation space for the filter element in the fresh air system, which usually also contains an air conditioning system. The air conditioning system and the filter system are often combined in a housing. For this reason, the filter elements must exhibit low flow resistances and/or pressure losses to be able to convey the airflow into the vehicle interior and thus meet safety requirements, such as preventing the windows from fogging up. This has the disadvantage that the fiber filter layer normally has an open-cell structure, such that the mechanical dust removal level of the filter element is normally quite low. Many filter media and/or filter fiber layer manufacturers therefore electrostatically charge the filter media in the production process. Consequently, the frequently electrostatically charged particles are often subsequently removed through electrostatic filtering. Even very fine particles of less than 0.3 μm can be removed with this filtering mechanism, without necessarily increasing the flow resistance and/or pressure losses in the filtering element. Unfortunately, the electrostatic charge obtained in the production process tends to diminish over time, as the filter element accumulates dust. The electrostatic charge of the filter is therefore most effective only at the start of its service life. This charge can drop significantly within a few weeks or months with high levels of air pollution.

Particles are electrostatically charged by ionizers. When placed upstream of the filter element, the particles in the airflow become charged. Moreover, the ions formed in the air also recharge the filter element slightly. This increases the filtering effect of the filter element by supplementing the mechanical filtering process with electrostatic particle removal maintained over a longer period.

The ionizers that are used often have a negative discharge electrode for generating a corona discharge with which the particles are charged. The negative corona discharge results in electrons accumulating on a discharge electrode, which normally has a series of sharp contours, e.g. spikes or needles, which then become highly accelerated, in particular in the close electrical proximity of the discharge electrode. The electrons consequently collide with gas molecules, losing another electron and becoming positively ionized. This results in a positive gas molecule, or ion, and two electrons. This effect occurs mostly with very high field strengths in close proximity to the discharge electrodes. At greater distances to the discharge electrodes, the quickly moving electrons tend to accumulate on gas molecules, thus forming negative ions. More gas ions are formed with a negative corona discharge than with a positive corona discharge, because the smaller electrons move more quickly. This facilitates the charging of the particles and therefore the removal thereof in the downstream filter element.

Both positive and negative ions are thus obtained in the airflow, which then bond with the particles. The net charge remains negative with a negative corona discharge, because electrons are introduced to the airflow.

The electrostatic charging of the filter element diminishes over time, because the electrostatic charge of the filter element is decreased by the layer of dust that accumulates on the filter element.

This type of ionizer is disclosed in WO 2020/263171 A1, for example. It contains a generator with first and second electrical terminals, and is configured to generate a high voltage between the first and second terminals. The ionizer has a discharge electrode connected to the first terminal. It also has a counter electrode at a distance thereto, connected to the ground. The second terminal is also grounded.

Other ionizers are disclosed in US Published Application No. 2021/0 021 107 A1, KR 10-2 205 159 B1, WO 2021/226639 A2, EP 3 056 364 B1, and EP 3 488 933 A1.

A general problem with ionizers and electrostatically charged filter systems equipped with these ionizers is that high voltage is applied to the discharge electrode when it is in use, and that it is theoretically possible to come in contact with the discharge electrode, e.g. during maintenance procedures in which the filter element has to be replaced. When switched on, the ionizer may be active, such that there is a high voltage at the discharge electrode. A person (male/female/other) near the discharge electrode when replacing the filter element is grounded and/or touches the vehicle, and is thus connected to the vehicle ground, and is thus at risk of discharging the electrode, in particular by inadvertently coming in contact therewith.

The problem addressed by the present invention is to create a better ionizer of the type described above, and a better filter system equipped with such, and a better motor vehicle equipped therewith, which is safer to use, in particular.

This problem is solved with the subject matter of the independent claims. Advantageous embodiments are the subject matter of the dependent claims.

The fundamental concept of the invention is to configure the ionizer such that a system is obtained for the discharge electrode that is insulated from the ground, i.e. a so-called IT system or IT network, in which IT stands for “isole-terre.” An IT network is therefore not grounded, i.e. it is entirely or at least substantially galvanically insulated from the ground. Consequently, a person can touch the discharge electrode without getting electrocuted. This effectively forms a contact safeguard, increasing the operational safety level for the ionizer and thus for the filter system and vehicle equipped therewith.

In this context, the term, “configuration,” means the same as “embody,” and/or “design,” and/or “programing,” such that the formulation, “configured such,” means the same as “embodied and/or designed, and/or programmed such.”

In detail, it is proposed that the discharge electrode and the counter electrode are connected to the ground with a very high impedance. It is not attempted to obtain a complete galvanic separation, and instead a high-impedance connection is obtained, in particular with a high-impedance resistor that prevents critical or dangerous current. In this context, a connection or resistance is high-impedance if the resistance is at least 500 times greater than the voltage in the system or network. In the present case, the high-impedance resistance is therefore at least 500 times greater than the voltage obtained with the generator. With a voltage of 10 kV, for example, the high-impedance connections or resistors have a resistance of at least 5 megohms. These high-impedance connections basically insulate or separate the discharge electrode and counter electrode from the ground. Furthermore, it is proposed that the counter electrode is connected to the second terminal in the IT network. Consequently, high voltage is only obtained between the discharge electrode and the counter electrode, without being grounded.

In an advantageous embodiment, the discharge electrode can also have a high-impedance connection to the first terminal. This limits the current such that if one comes in contact with the discharge electrode, the current is reduced to a harmless level.

In an advantageous embodiment, the discharge electrode can have a high-impedance connection to the first terminal through a first resistor. This resistor then represents the aforementioned limiter, and consequently a safeguard against contact therewith.

This first resistor can have a resistance of at least 5 megohms and at most 20 megohms, in particular 11 megohms±20%. Consequently, the first resistance results in a relatively low current, which is nevertheless necessary for generating the corona discharge when the ionizer is in use.

In another embodiment, the discharge electrode can be grounded with a second high-impedance resistor. The use of this resistor allows for a simple and inexpensive design. The second resistor can have a resistance of at least 100 megohms and at most 500 megohms. The resistance of the second resistor is preferably 400 to 500 megohms. With this resistance range, it is basically impossible to obtain a significant current from the discharge electrode to the ground.

The counter electrode can preferably have a high-impedance connection to the ground through a third resistor. The use of a resistor in this case also allows for an inexpensive and reliable implementation. The third resistor can have a resistance of at least 100 megohms and at most 500 megohms. The resistance is preferably 100 to 200 megohms. This also eliminates the possibility of significant current between the counter electrode and the ground.

A configuration in which the second resistor and third resistor have a cumulative resistance of 500 megohms to 700 megohms has proven to be particularly advantageous. A cumulative resistance of 600 megohms±10% is preferred. The second resistor can also have a higher resistance, in particular at least double, than that of the third resistor. This is advantageous because there is a greater difference in the potential to the ground at the discharge electrode than between the counter electrode and the ground. If the second resistor has a higher resistance, the safety level is further increased. In a preferred embodiment, a connection point forming a high-impedance connection from the discharge electrode and counter electrode to the ground can be placed between the second and third resistor.

In an advantageous embodiment, the generator can contain a high voltage source for providing and/or generating high voltage, and an isolating transformer, which is connected to the generator at the first end and contains the first and second terminals at the second end. Direct contact to the high voltage source is prevented by this transformer, further improving the safety level.

The generator can be designed to generate a high voltage of at least 7 kV, at most 10 kV, and preferably 8 kV. This level has proven to obtain particularly good results with regard to ionizing particles in the airflow.

The electrostatic filter system for a motor vehicle obtained with the invention contains a flow channel for the airflow, a filter element designed as a particle filter, which is placed in the flow channel such that the airflows through the filter element, and an ionizer of the type described above. The discharge electrode and counter electrode are placed in the flow channel in the filter system upstream of the filter element, such that the air flows between the discharge electrode and the counter electrode. When the filter system is in use, the corona discharge is built up between the discharge electrode and the counter electrode. The air then flows through this corona discharge, exposing the particles therein to the electrons. The filter element can then be electrostatically charged to improve the accumulation of ionized particles. The ionizer can thus at least partially recharge the filter element when in use.

A vehicle obtained with the invention contains an interior and a fresh air system for supplying fresh air to the interior from the vehicle's environment. An electronic filter system of the type described above is placed in the fresh air system such that the fresh air flows through the flow channel in the filter system, thus forming the airflow.

In an advantageous embodiment, the ground for the ionizer can be formed by the vehicle ground. The vehicle can also contain an air conditioner, which is downstream of the filter system in the fresh air system. The air conditioner and the filter system can both be contained in the same housing.

Other features and advantages of the invention can be derived from the dependent claims, drawings, and descriptions of the drawings.

It is understood that the features specified above and described below can be used not only in the given combinations, but also in other combinations or in and of themselves, without abandoning the scope of the invention defined by the claims. Components of a higher-order unit specified above and below, e.g. a system, device, or assembly, that are indicated separately, can be separate components of this unit, or integral parts or sections of this unit, even if otherwise indicated in the drawings.

Preferred exemplary embodiments of the invention are shown in the drawings and shall be explained in greater detail below, in which the same reference symbols are used for identical, similar, or functionally similar components.

Therein, schematically:

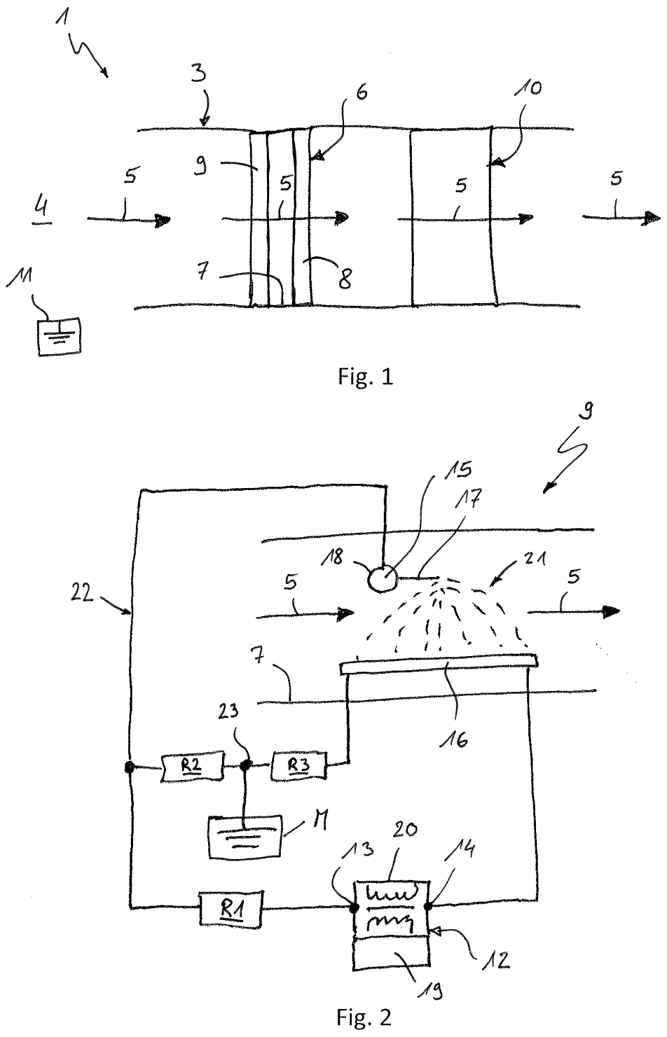

FIG. 1 shows a highly simplified illustration a fresh air system with an ionizer in a motor vehicle, and

FIG. 2 shows a highly simplified circuit diagram for the ionizer.

The part of the vehicle 1 shown in FIG. 1 contains a vehicle interior 2 and a fresh air system 3 that supplies fresh air from outside 4 the vehicle 1 to the interior 2. This forms an airflow 5, indicated by arrows in FIGS. 1 and 2. The fresh air system 3 contains an electrostatic filter system 6 with a flow channel 7. The filter system 6 is incorporated in the fresh air system 3 such that the airflow 5 also flows through the flow channel 7.

The electrostatic filter system 6 contains the flow channel 7 for the airflow 5 and a filter element 8 configured as a particle filter, which is placed in the flow channel 7 such that the airflow 5 flows through the filter element 8. The filter system 6 also has an ionizer 9 with which particles in the airflow 5 can be ionized to improve the accumulation of particles in the filter element 8. The filter element 8 can be electrostatically charged to improve the accumulation of the ionized particles.

The vehicle 1 can also have an air conditioner 10 for the airflow 5 or fresh air. The air conditioner 10 can have a cooler and/or heater (not shown) with which the fresh air can be cooled, heated, and potentially dehumidified. The air conditioner 10 is ideally incorporated in the fresh air system 3 downstream of the filter system 6 and the airflow 5 can flow through it. The air conditioner 10 and filter system 6 can be integrated in the same housing, which is not shown. The vehicle 1 can also have a ground 11, normally formed by the body of the vehicle 1.

The ionizer 9 in FIG. 2 has a generator 12 with a first terminal 13 and second terminal 14. The generator 12 generates high voltage between the first terminal 13 and second terminal 14. The ionizer 9 also has at least one discharge electrode 15 and at least one counter electrode 16. The discharge electrode 15 is connected to the first terminal 13. The counter electrode 16 is connected to the ground M, and at a distance to the discharge electrode 15. The discharge electrode 15 has a least one contour 17, forming a spike or needle. This discharge electrode 15 can have numerous spikes 17 spaced apart and adjacent to one another over the length of the electrode 15. The discharge electrode 15 extends perpendicular to the drawing plane in FIG. 2, such that only one spike 17 can be seen. The spike 17 is parallel to the airflow 5, protruding from the body 18 of the discharge electrode 15. The counter electrode 16 is formed by a plate that is parallel to the airflow 5 and to the length of the discharge electrode 15. The plane of the counter electrode 15 is perpendicular to the drawing plane in FIG. 2. The discharge electrode 15 and counter electrode 16 are upstream of the filter element 8 in the airflow 5 flowing through the flow channel 7 in FIG. 2, such that the airflow 5 flows between the discharge electrode 15 and the counter electrode 16. There are normally numerous discharge electrodes 15 and counter electrodes 16, which are adjacent to and spaced apart from one another at a right angle to the flow direction.

The counter electrode 15 in the ionizer 9 shown here is connected to the second terminal 14 in the generator 12. The discharge electrode 15 and counter electrode 15 also have a high-impedance connection to the ground M. The discharge electrode 15 can also have a high-impedance connection to the first terminal 13. This high-impedance connection of the discharge electrode 15 to the first terminal 13 is obtained with a first resistor R1 in FIG. 2, which is connected in a series to the first terminal 13. The first resistor R1 has a high impedance, with a resistance of 5 megohms to 20 megohms. The resistor R1 in this preferred embodiment can have a resistance of 11 megohms.

The discharge electrode 15 can also have a high-impedance connection to the ground M through a second resistor R2. The connection of the discharge electrode 15 to the ground M with the second resistor R2 is parallel to the connection of the discharge electrode 15 to the first terminal 13 with the first resistor R1. The second resistor R2 can have a resistance of 100 megohms to 500 megohms. The second resistor R2 in this preferred embodiment can have a resistance of 500 megohms.

The counter electrode 15 can have a high-impedance connection to the ground M through a third resistor R3. The connection of the counter electrode 15 to the ground M through the third resistor R3 is parallel to the connection of the counter electrode 15 to the second terminal 14. The third resistor R3 can have a resistance of 100 megohms to 500 megohms. The third resistor R3 in this preferred embodiment can have a resistance of 100 megohms.

Because both the discharge electrode 15 and the counter electrode 15 have high-impedance connections to the ground M, and a short circuit between the discharge electrode 15 and counter electrode 16 should be prevented, there is a connection point 23 through which the discharge electrode 15 and counter electrode 16 have a high-impedance connection to the ground M, between the second resistor R2 and third resistor R3.

The high-impedance connection of the discharge electrode 15 and counter electrode 16 to the ground M is such that the second resistor R2 and third resistor R3 have a cumulative resistance of 500 megohms to 700 megohms, preferably 600 megohms. In this embodiment, the second resistor R2 has a resistance of 500 megohms, while the third resistor R3 has a resistance of 100 megohms. This results in 600 megohms for the cumulative resistance of the second resistor R2 and third resistor R3. It is furthermore preferred that the second resistor R2 has a higher resistance than the third resistor R3. Ideally, the resistance of the second resistor R2 is at least twice that of the third resistor R3. In this preferred embodiment, the second resistor R2, with a resistance of 500 megohms, has five times the resistance of the third resistor R3 with 100 megohms.

The generator 12 contains a high voltage source 19 for providing or generating high voltage. The generator 12 also has an isolating transformer 20, the first end of which is connected to the high voltage source 19, and the second end of which contains the first terminal 13 and second terminal 14. The generator 12, or high voltage source 19, can be configured to generate a high voltage of 7 kV to 10 kV. A high voltage of 8 kV is preferably used in the preferred embodiment shown here.

The ionizer 9 generates a corona discharge 21 when in use, starting from the tips of the spikes 17, spreading toward the counter electrode 16. The corona discharge 21 is indicated by broken lines in FIG. 2. The ionizer 9 is placed in the filter system 6, or its flow channel 7, such that the airflow 5 flows through this corona discharge 21. When used in a vehicle, the ground M is preferably formed by the vehicle ground 11.

The high-impedance connections of the discharge electrode 15 and counter electrode 16 to the ground M generates an IT network 22 in the ionizer 9, and is therefore not grounded. The discharge electrode 15 and counter electrode 16 are basically isolated from the ground M by the high-impedance resistors R2 and R3. This means that a grounded person can come in contact with the discharge electrode 15 without risk of electrocution. Even if the discharge electrode 15 is touched, there is no danger from the high voltage. Furthermore, the first resistor R1 forms a current limiter, which reduces any current discharged by the discharge electrode 15 through a grounded person to a harmless level. Even if a higher current could flow through the discharge electrode 15, e.g. if the first resistor R1 were defective, contact to the discharge electrode 15 by a grounded person would still be harmless, because the high-impedance connection to the ground M would prevent any current flowing between the ungrounded IT system 22 and the grounded person.

In summary, the ionizer 9 used herein is characterized in that both the counter electrode 15 and the discharge electrode 16 have a high-impedance connection to the ground M, or have a high-impedance insulation from the ground, and are therefore basically galvanically isolated therefrom. This forms the IT network 22, i.e. a system insulated from the ground. With such an IT network 22, there is no danger in touching a lead. Current requires a source and a load. One of these is missing when touching just one lead in an IT network 22. A high impedance is obtained when the resistance is 500 times that of the voltage. This means that with 10 kV, all of the resistances must be greater than 5 megohms. The IT network 22 is obtained with the voltage source 19 insulated by the isolating transformer 20, which provides or generates a high voltage of at least 7 kV, preferably 8 kV, and at most 10 KV. The discharge electrode 15 is connected in series with the first resistor R1 to obtain a current limiter. The first resistor R1 has a resistance of at least 5 megohms, at most 20 megohms, and preferably 11 megohms. To obtain the high-impedance insulation from the ground M, the second resistor R2 is used for the discharge electrode 15, and the third resistor R3 is used for the counter electrode 16. The resistances for the second resistor R2 and third resistor R3 are at least 100 megohms and at most 500 megohms, with preferably a cumulative resistance of 600 megohms. Furthermore, the resistance of the second resistor R2 is preferably greater than that of the third resistor R3.

The specification can be readily understood with reference to the following Numbered Paragraphs:

Numbered Paragraph 1. An ionizer (9) for an electrostatic air filter system (6), preferably in a motor vehicle (1), which has
a generator (12) with a first terminal (13) and second terminal (14), and which is configured to generate a high voltage between the first terminal (13) and second terminal (14),
at least one discharge electrode (15) connected to the first terminal (13), and
at least one counter electrode (16) at a distance to the discharge electrode (15), which is connected to the ground (M), characterized in that
the counter electrode (16) is connected to the second terminal (14), and
the discharge electrode (16) and counter electrode (16) have a high-impedance connection to the ground (M).

Numbered Paragraph 2. The ionizer (9) according to Numbered Paragraph 1, characterized in that the discharge electrode (15) has a high-impedance connection to the first terminal (13).

Numbered Paragraph 3. The ionizer (9) according to Numbered Paragraph 2, characterized in that the discharge electrode (15) has a high-impedance connection to the first terminal (13) through a first resistor (R1).

Numbered Paragraph 4. The ionizer (9) according to Numbered Paragraph 3, characterized in that the first resistor (R1) has a resistance of at least 5 megohms and at most 20 megohms, in particular 11 megohms.

Numbered Paragraph 5. The ionizer (9) according to any of the preceding Numbered Paragraphs, characterized in that the discharge electrode (15) has a high-impedance connection to the ground (M) through a second resistor (R2).

Numbered Paragraph 6. The ionizer (9) according to Numbered Paragraph 5, characterized in that the second resistor (R2) has a resistance of at least 100 megohms, at most 500 megohms, and preferably 400 to 500 megohms.

Numbered Paragraph 7. The ionizer (9) according to any of the preceding Numbered Paragraphs, characterized in that the counter electrode (16) has a high-impedance connection to the ground (M) through a third resistor (R3).

Numbered Paragraph 8. The ionizer (9) according to Numbered Paragraph 7, characterized in that the third resistor (R3) has a resistance of at least 100 megohms, at most 500 megohms, and preferably 100 to 200 megohms.

Numbered Paragraph 9. The ionizer (9) according to Numbered Paragraph 5 or 6 and according to Numbered Paragraph 7 or 8, characterized in that
the second resistor (R2) and third resistor (R3) have a cumulative resistance of 500 megohms to 700 megohms, and preferably 600 megohms, and/or
the second resistor (R2) has a greater resistance than the third resistor (R3), and/or
there is a connection point (23), through which the discharge electrode (15) and counter electrode (16) have a high-impedance connection to the ground (M), which is between the second resistor (R2) and third resistor (R3).

Numbered Paragraph 10. The ionizer (9) according to any of the preceding Numbered Paragraphs, characterized in that the generator (12) contains a high voltage source (19) for providing and/or generating high voltage, and an isolating transformer (20), the first end of which is connected to the high voltage source (19), and the second end of which contains the first terminal (13) and second terminal (14).

Numbered Paragraph 11. The ionizer (9) according to any of the preceding Numbered Paragraphs, characterized in that the generator (12) is designed to generate a high voltage of at least 7 kV, a most 10 KV, in particular 8 kV.

Numbered Paragraph 12. An electrostatic filter system (6) for a motor vehicle (1), which has
a flow channel (7) for an airflow (5),
a filter element (8) in the flow channel (7) conducting the airflow (5) through the filter element (8), and
an ionizer (9) according to any of the preceding Numbered Paragraphs,
wherein the discharge electrode (15) and counter electrode (16) are upstream of the filter element (8) in the airflow (5) through the flow channel (7), such that the airflow (5) flows between the discharge electrode (15) and the counter electrode (16).

Numbered Paragraph 13. A motor vehicle (1) that has
an interior (2), and
a fresh air system (3) for supplying fresh air from outside (4) the vehicle (1) to the interior (2),
wherein there is an electrostatic filter system (6) according to Numbered Paragraph 12 in the fresh air system (3), and
wherein the fresh air flows through the flow channel (7) in the filter system (6), and forms the airflow (5).

Numbered Paragraph 14. The motor vehicle (1) according to Numbered Paragraph 13, characterized in that
the ground (M) is formed by a vehicle ground (11), and/or
the vehicle (1) contains an air conditioner (10) for the fresh air, which is downstream of the filter system (6) in the fresh air system (3).

1-14. (canceled)

15. An ionizer for an electrostatic air filter system, preferably in a motor vehicle, which has
a generator with a first terminal and second terminal, and which is configured to generate a high voltage between the first terminal and second terminal,
at least one discharge electrode connected to the first terminal, and
at least one counter electrode at a distance to the discharge electrode, which is connected to the ground,
wherein
the counter electrode is connected to the second terminal, and
the discharge electrode and counter electrode have a high-impedance connection to the ground.

16. The ionizer according to claim 15, wherein the discharge electrode has a high-impedance connection to the first terminal.

17. The ionizer according to claim 16, wherein the discharge electrode has a high-impedance connection to the first terminal through a first resistor.

18. The ionizer according to claim 17, wherein the first resistor has a resistance of at least 5 megohms and at most 20 megohms.

19. The ionizer according to claim 15, wherein the discharge electrode has a high-impedance connection to the ground through a second resistor.

20. The ionizer according to claim 19, wherein the second resistor has a resistance of at least 100 megohms and at most 500 megohms.

21. The ionizer according to claim 15, wherein the counter electrode has a high-impedance connection to the ground through a third resistor.

22. The ionizer according to claim 21, characterized in that the third resistor has a resistance of at least 100 megohms and at most 500 megohms.

23. The ionizer according to claim 19, wherein
the second resistor and third resistor have a cumulative resistance of 500 megohms to 700 megohms, and/or
the second resistor has a greater resistance than the third resistor, and/or
there is a connection point, through which the discharge electrode and counter electrode have a high-impedance connection to the ground, which is between the second resistor and third resistor.

24. The ionizer according to claim 15, wherein the generator contains a high voltage source for providing and/or generating high voltage, and an isolating transformer, the first end of which is connected to the high voltage source, and the second end of which contains the first terminal and second terminal.

25. The ionizer according to claim 15, wherein the generator is designed to generate a high voltage of at least 7 kV and at most 10 kV.

26. An electrostatic filter system for a motor vehicle, comprising
a flow channel for an airflow,
a filter element in the flow channel conducting the airflow through the filter element, and
an ionizer according to claim 15,
wherein the discharge electrode and counter electrode are upstream of the filter element in the airflow through the flow channel, such that the airflow flows between the discharge electrode and the counter electrode.

27. A motor vehicle comprising
an interior, and
a fresh air system for supplying fresh air from outside the vehicle to the interior,
further comprising an electrostatic filter system according to claim 26 in the fresh air system, and
wherein the fresh air flows through the flow channel in the filter system, and forms the airflow.

28. The motor vehicle according to claim 27, wherein
the ground is formed by a vehicle ground, and/or
the vehicle contains an air conditioner for the fresh air, which is downstream of the filter system in the fresh air system.

29. The ionizer according to claim 23, wherein the counter electrode has a high-impedance connection to the ground through a third resistor.

30. The ionizer according to claim 23, wherein the third resistor has a resistance of at least 100 megaohms.

31. The ionizer according to claim 18, wherein the first resistor has a resistance of 11 megohms.

32. The ionizer according to claim 20, wherein the second resistor has a resistance of at least 400 megaohms and at most 500 megohms.

33. The ionizer of according to claim 21, wherein the third resistor has a resistance of at most 200 megaohms.

34. The ionizer of claim 23, wherein the second and third resistor have a cumulative resistance of 600 megaohms.

35. The ionizer according to claim 25, wherein the generator is designed to generate a high voltage of 8 kV.
